(19) United States
(12) Patent Application Publication
(10) Pub. No.: US 2011/0225203 A1
(43) Pub. Date: Sep. 15, 2011

(54) SYSTEMS AND METHODS FOR TRACKING AND EVALUATING REVIEW TASKS

(75) Inventors: William Hart-Davidson, Williamston, MI (US); Jeffrey Grabill, Okemos, MI (US); Michael McLeod, Haslett, MI (US)

(73) Assignee: BOARD OF TRUSTEES OF MICHIGAN STATE UNIVERSITY, EAST LANSING, MI (US)

(21) Appl. No.: 13/045,632

(22) Filed: Mar. 11, 2011

Related U.S. Application Data
(60) Provisional application No. 61/313,108, filed on Mar. 11, 2010.

(51) Int. Cl. G06F 17/30

(52) U.S. Cl. 707/792; 707/E17.055

(57) ABSTRACT

Methods and systems for tracking and evaluating review tasks. In one example embodiment, a method for tracking and evaluating review tasks includes operations for defining a review task, receiving a review response, scoring the review response, and storing a review score. The defining a review task can include receiving a plurality of parameters including a review target and a reviewer. The review response can be received from a reviewer and can be associated with the review task. The scoring the review response can include creating a review score for the reviewer. The review score can be stored in association with the reviewer and the review response within a database.

This application claims the benefit of priority under 35 U.S.C. 119(e) to U.S. Provisional Patent Application Ser. No. 61/313,108, filed on Mar. 11, 2010, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, Michigan State University. All Rights Reserved.

### TECHNICAL FIELD

Various embodiments relate generally to the field of data processing, and in particular, but not by way of limitation, to systems and methods for creating, tracking, and evaluating review tasks.

### BACKGROUND

The advent of computerized word processing tools has vastly improved the ability of knowledge workers to produce high quality documents. Modern word processing tools, such as Microsoft® Word®, include a vast array of features to assist in creating and editing documents. For example, Word® contains built-in spelling and grammar correction tools. Word® also provides feature to assist in formatting documents to have a more professional look and feel. Word® also includes a group of features to assist in reviewing and revising documents. For example, using the “track changes” feature will highlight any suggested corrections or revisions added to a document.

Reviewing documents and other types of work product is a common and often critical task within the work place. Reviewing work product is also a common task within all levels of academia, especially post-secondary instructions. As noted above, some computerized word processing applications include features focused on assisting with the review and revision process. However, most of the review and revision tools place an emphasis on the revision of the document, not the review process itself.

### BRIEF DESCRIPTION OF THE DRAWINGS

Some embodiments are illustrated by way of example and not limitation in the figures of the accompanying drawings in which:

FIG. 1 is a block diagram that depicts an example system for tracking and evaluating review tasks.

FIG. 2 is a block diagram depicting an example system configured for tracking and evaluating review tasks within a local area network and across a wide area network.

FIG. 3 is a block diagram depicting an example system for tracking and evaluating review tasks within a local area network and across a wide area network.

FIG. 4 is a flowchart depicting an example method for tracking and evaluating review tasks.

FIG. 5 is a flowchart depicting an example method for creating and conducting review tasks.

FIG. 6 is a flowchart depicting an example method for tracking and evaluating review tasks and associated review responses.

FIG. 7 is a flowchart depicting an example method for scoring review responses including a series of optional scoring operations.

FIG. 8A-B are example user-interface screens for creating a review task.

FIG. 9A-C are example user-interface screens for selecting reviewers to associate with a review task.

FIG. 10A-B are example user-interface screens for establishing review metrics to associate with a review task.

FIG. 11A-B are example user-interface screens for creating a list of review criteria to associate with a review task.

FIG. 12A-B are example user-interface screens for selecting review targets to associate with a review task.

FIG. 13A-B are example user-interface screens for a reviewer to view review details associated with a review task.

FIG. 14A-B are example user-interface screens for a reviewer to respond to review criteria associated with a review task.

FIG. 15 is an example user-interface screen for a reviewer to respond to a review task.

FIG. 16 is an example user-interface screen providing an overview of one or more review tasks.

FIG. 17 is an example user-interface screen providing detail associated with a specific review task response.

FIG. 18A-B are example user-interface screens displaying a collection of review responses and associated notes.

FIG. 19 is an example user-interface screen providing a portfolio dashboard view for an individual reviewer.

FIG. 20 is an example user-interface screen providing review evaluation details associated with a specific individual review response.

FIG. 21A-B are example user-interface screens providing user evaluation details related to activities as a reviewer and a writer.

FIG. 22 is a block diagram of a machine in the example form of a computer system within which instructions for causing the machine to perform any one or more of the methodologies discussed herein may be executed.

### DETAILED DESCRIPTION

Disclosed herein are various embodiments (e.g., examples) of the present invention for providing methods and systems for tracking and evaluating review tasks. Tracking and evaluating review tasks can be used to assist in teaching the task of providing constructive feedback concerning a written document or similar authored work. The systems and methods discussed can also be used in a professional setting to track and evaluate work product, such as within a law office or any workplace where written materials are routinely created and reviewed.

The ability to provide effective writing feedback is an important skill in academia and in the workplace, but the way writing review is carried out within typical writing software, such as Microsoft® Word® (from Microsoft Corp of Redmond Wash.), makes review difficult to assess and, therefore, difficult to learn. As noted above, computerized word processing application tend to focus on improving the revision process, not in allowing for evaluating the quality of the actual review.

Existing writing software that includes any sort of review functionality regards review either as an afterthought or an ancillary activity. For example, within Microsoft® Word® review is primary a mechanism to assist in creating the next version of a text. The “track changes” functionality in Microsoft® Word® only tracks direct edits made to a document, which the original author can choose to “accept” or “reject.” The track changes functionality can contribute to the evolution of a text, but how does not provide a mechanism for informing the editor about the value of the suggestions provided within the review. How does the editor know if the edits were useful, and if not, how to make more useful revisions in the future? Other software will allow users (e.g., co-workers, classmates, etc) to “comment” on the document, but then that comment is treated as just another piece of descriptive information, like the document title or the day it was created (e.g., metadata). Like the track changes functionality, the reviewer's addition of metadata is the end of the reviewer's interaction with the reviewed document.

Teachers of writing consider “learning to become better reviewers of others' writing” as a learning goal for students. For students majoring in writing, particularly technical or professional writing, becoming a good reviewer is an important career skill. But most writing teachers know that teaching review poses a significant challenge: reading and responding to student writing AND to reviews of that writing can create an overwhelming workload. Thus, a system or method to assist in streamlining the process of reviewing creative works and subsequently evaluating the reviewer's responses would be very beneficial within an academic environment.

The systems and methods for creating, tracking, and evaluating review tasks discussed within this specification focus on the review task (or review object) as the central aspect. In an example, the disclosed approach to review allows for:
One review task, many review targets (e.g., texts, documents, digital files, photographs, presentations, etc . . . )
One review task, many reviewers (e. g., individuals providing review of the review target(s) associated with the review task)
Direct feedback on review responses provided by reviewers, including qualitative responses and quantitative responses.
Real-time data about the status and progress of the review.
Review responses stored over time for review coordinators, instructors, and reviewers (e. g., students).
   Review is handled as a distinct task separate from document creation and the artifacts created during the review process are stored separately while maintaining in association with the reviewed document. The system supports multiple reviewers and multiple review targets (e. g., documents). The system can provide reviewers with feedback as to which of their suggested edits were used in the revision of the review target. The review results for multiple reviewers can be tracked over time and analyzed. The system can include a “helpfulness algorithm” also referred to as a review score, which is used to evaluate review. For example, a review score can be enhanced if it is determined that the reviewers suggested edits were incorporated within a subsequent revision of the review target. The system also allows authors to specify metrics and criteria to be used by the reviewer during the review.

The review system discussed in this specification can be used within various different types of review environments, including but not limited to: blind peer review for academic conference, formative peer review for a writing classroom, screening evaluation of potential employee application documents, and work product review within a business environment.

### DEFINITIONS

The following definitions are given by way of example and are not intended to be construed as limiting. A person of skill in the art may understand some of the terms defined below to include additional meaning when read in the context of this specification.

Review task (object)—Within the following specification, a review task refers to a request to review one or more review targets. A review task can be assigned to one or more reviewers and can include additional metadata related to the requested review. In certain examples, a review task (or review object) is used to refer to a data structure used to retain information related to a requested review. A review task (review object) can contain references (or copies) of one or more review targets, identifying information for one or more reviewers, and other misceneous review metadata.

Review target—Within the following specification, a review target refers to a document, presentation, graphic file, or other digital representation of a work product that is the subject of the requested review. In some examples, a review target can be a copy of the actual digital file or merely a reference to the digital or non-digital work product.

Review response—Within the following specification, a review response generally refers to a reviewer's response to a review task. A review response can contain multiple response items, e.g., individual suggested edits, corrections, review criteria responses or annotations. A review response can also contain a link or copy of the review target, in situations where the actual review was conducted within a third-party software package.

Review score—Within the following specification, a review score refers to a score or ranking assigned to a reviewer's review response. The review score is intended to provide an indication of how useful (or helpful) the reviewer's response was to the author of the review target or the entity that requested the review.

Reviewer—Within the following specification, a reviewer is generally a person conducting a requested review. However, a reviewer can also include an automated process, such as spell checking, grammar checking, or legal citation checking, which all can be done automatically.

Likert scale—A Liker scale is a psychometric scale commonly used in questionnaires. When responding to a Likert item or question, respondents are requested to specify the level of agreement is statement. For example, a format of a typical five level Likert item is as follows:
1. Strongly disagree
2. Disagree
3. Neither agree nor disagree
4. Agree
5. Strongly agree

Criteria (review criteria)—Within the following specification, review criteria (or if singular a review criterion) generally represent standards or guidelines provided to reviewers for use when evaluating a review target. Review criteria can be specified (or selected) by a review coordinator or an author during creation of a review task. Review criteria can be stored for reuse in sequent reviews.

### EXAMPLE SYSTEMS

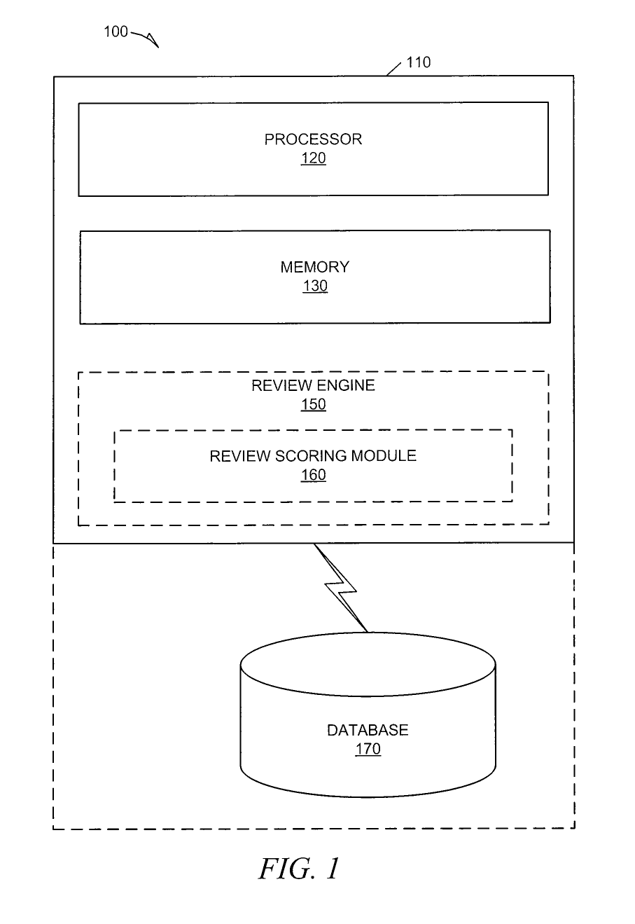

FIG. 1 is a block diagram that depicts an example system 100 for tracking and evaluating review tasks. The system 100 can include a server 110 and a database 170. The server 110 can include one or more processors 120 and a memory 130. In certain examples, the server 110 can also include a review engine 150 and review scoring module 160. In some examples, the database 170 is external to the server 110. In other examples, the database 170 can be internal to the server 110. In an internal example, the database 170 can be a hierarchical file system within the server 110. The server 110 can provide a host platform for creating, tracking, evaluating, and storing review tasks.

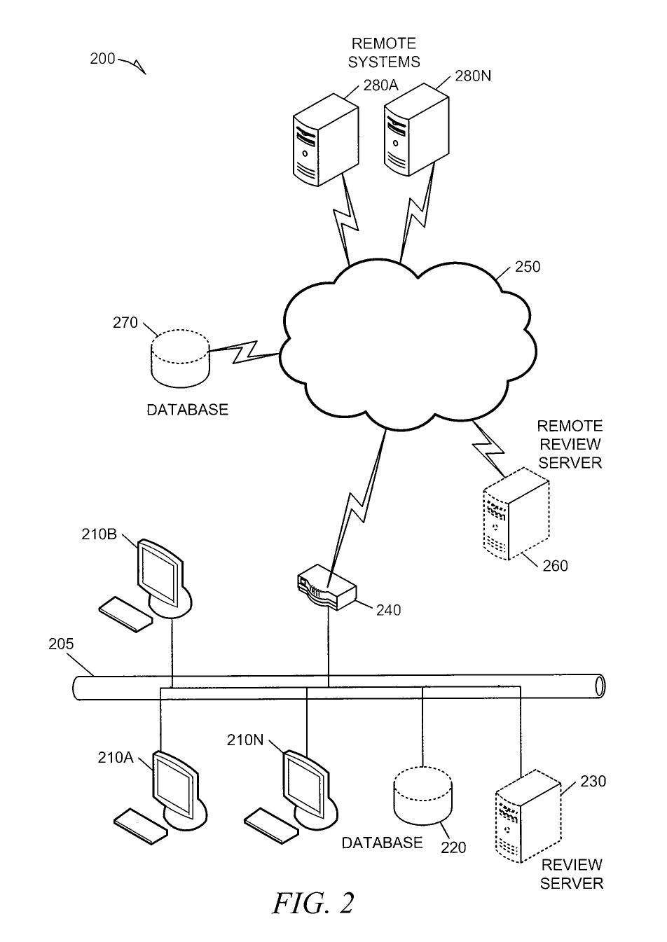

FIG. 2 is a block diagram depicting an example system 200 configured for creating, tracking, and evaluating review tasks within a local area network 205 and across a wide area network 250. The system 200 depicts both a review server 230 and a remote review server 260, to enable deployment in a local or remote configuration of a system for creating, tracking, and evaluating review tasks. In this example, the system 200 includes a local area network 205, local clients 210A, 210B, . . . 210N (collectively referred to as “local clients 210”), a local database 220, a review server 230, a router 240, a wide area network 250 (e.g., the Internet), a remote review server 260, a remote database 270, and remote clients 280A . . . 280N (collectively referred to as “remote clients 280”).

In an example, the review server 230 can be used by both the clients 210 and the remote clients 280 to conduct reviews. The local clients 210 can access the review server 230 over the local area network 205, while the remote clients 280 can access the review server 230 over the wide area network 250 (e.g., connecting through the router 240 to the review server 230). In another example, the remote review server 260 can be used by the local clients 210 and the remote clients 280 (collectively referred to as “clients 210, 280”) to conduct reviews. In this example, the clients 210, 280 connect to the remote review server 260 over the wide area network 250.

The review servers, review server 230 and remote review server 260, can be configured to deliver review applications via protocols that can be interpreted by standard web browsers, such as hypertext markup language (HTTP). Thus, the clients 210, 280 can perform review activities interacting with the review server 230 through Microsoft Internet Explorer® (from Microsoft, Corp. of Redmond, Wash.) or some similar web browser. The review servers 230, 260 can also be configured to communicate via e-mail, (e.g., simple mail transport protocol). In an example, notifications of pending review tasks can be communicated to the clients 210, 280 via e-mail. In certain examples, the review servers 230, 260 can also receive review responses sent by any of the clients 210, 280 via e-mail. In some examples, when the review servers 230, 260 receive review response via e-mail, the e-mail can be automatically parsed to extract the review response data. For example, in certain examples, Microsoft® Word® can be used for reviewing certain review targets. In this example, the reviewer will insert comments, and make corrections using the “track changes” feature within Microsoft® Word®. When the reviewer returns the completed review task to the review server 230 via e-mail. The review server 230 can detect the Microsoft® Word® file, extract it from the e-mail, and parse out the reviewer's comments and corrections. In some examples, the parsed out review response data (also referred to as “review response items”, or simply “response items”) can be stored within the database 220 associated with the review task.

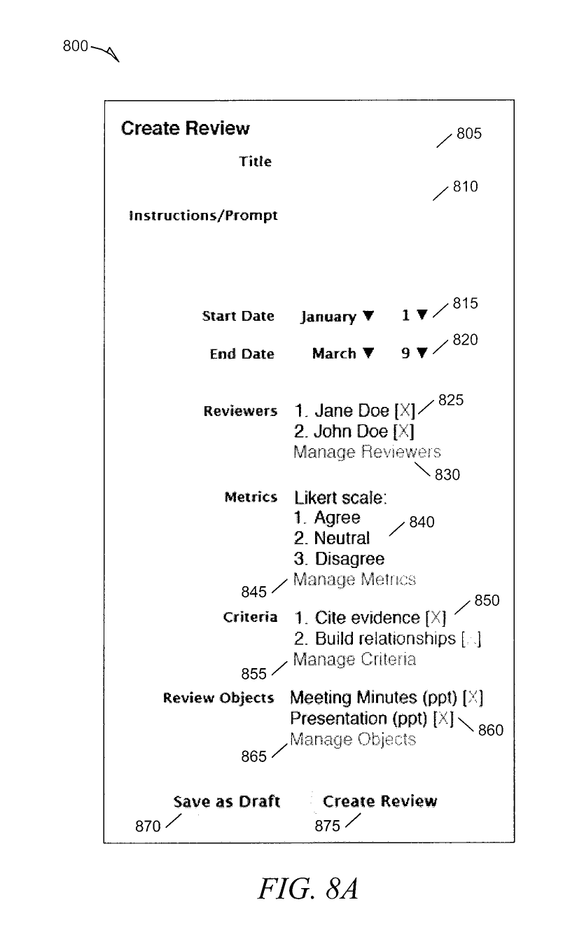

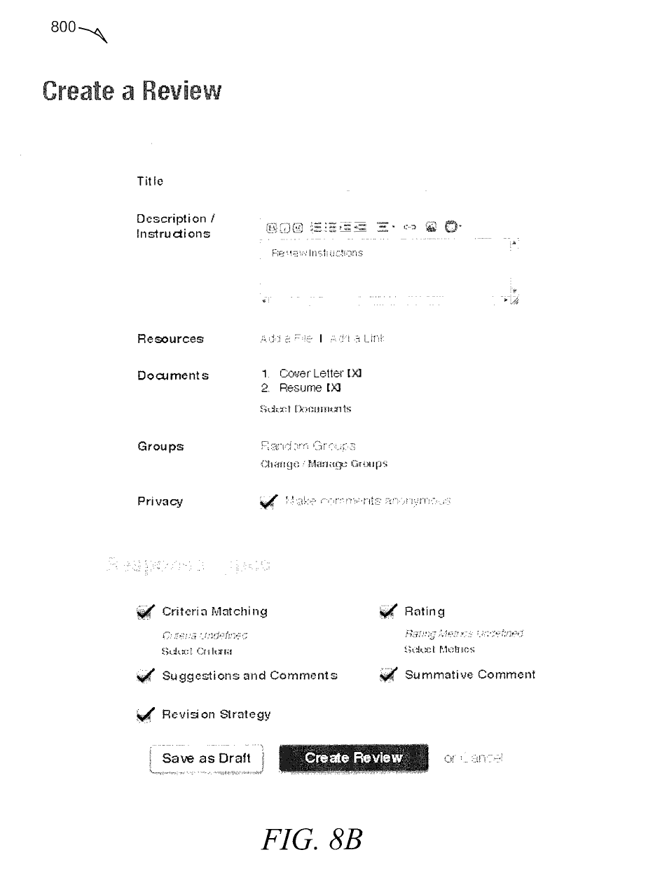

In some examples, the clients 210, 280 can use a dedicated review application running locally on the clients 210, 280 to access the review tasks stored on the review servers 230, 260 (e.g., in a classic client/server architecture). In these examples, the review application can provide various user-interface screens, such as those depicted in FIGS. 8-20 described in detail below. Alternatively, similar user-interface screens can be delivered through a web browser interface as described above.

### EXAMPLE DATA STRUCTURES

The following examples illustrate data structures that can be used by the systems described above to create, track, evaluate, and store review related information.

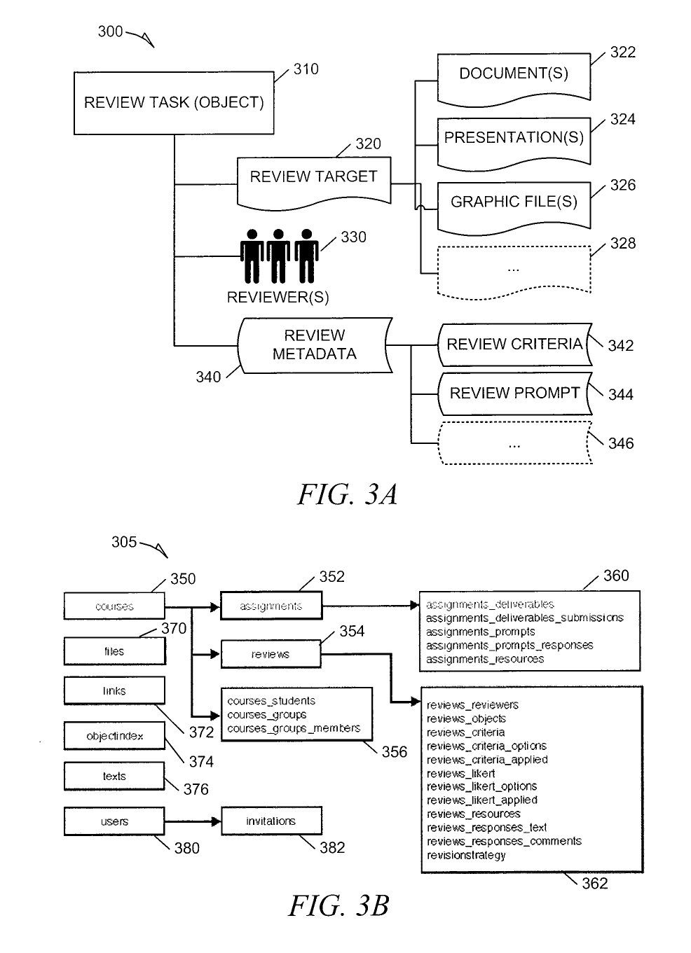

FIG. 3A is a block diagram generally illustrating an example review task 310 used by systems and methods for creating, tracking, and evaluating reviews. In this example, the review task 310 includes a review target 320, one or more reviewers 330, and review metadata 340. The review target 320 can include documents 322, presentations 324, graphics files 326, and any additional data files (depicted within FIG. 3A as element 328). In this example, the reviewers 330 can represent any person or automated process requested to provide a review response in reference to one or more of the review targets 320.

The review metadata 340 can include review criteria 342, a review prompt 344, and any additional information contained within the review task 310 (depicted within FIG. 3A as element 346). In certain examples, the review criteria 342 can include specific tasks assigned to the reviewers 330 to be completed in reference to the review target 320. For example, a review criterion of the review criteria 342 can include determining whether the review target 320 answers a particular question. The review criteria 342 can include both qualitative and quantitative criteria. For example, the review criteria 342 can include questions that request answer in the form of a Likert scale. In this example, the review prompt 344 can include a description of the review task 310 provided by the author or review coordinator. As noted by element 346 the review metadata 340 can include optional additional information related to the review task 310. For example, the review metadata can include an overall rating of quality for each of the review targets 320 associated with the review task 310.

FIG. 3B is a block diagram generally illustrating an example database structure 305 used for creating, tracking, evaluating, and storing review tasks in an academic environment. In this example, the database structure 305 can include the following tables: courses 350, files 370, links 372, object index 374, texts 376, and users 380. The courses table 350 can include links to assignments table 352 and a reviews table 354. In an example, the courses table 350 can include the courses detail 356, which includes references to students, groups, and group members. The assignments table 352 can include the assignment details 360, which in this example includes deliverables, deliverable submissions, prompts, prompt responses, and resources. In an example, the reviews table 354 can include review details 362, which in this example includes reviewers, objects, criteria, criteria options, criteria applied, likert items, likert options, likert applied, responses, response text, response comments, and revision strategy. The users table 380 can include references to an invitations table 382.

### EXAMPLE METHODS

The following examples illustrate how the systems discussed above can be used to create, track, and evaluate review tasks.

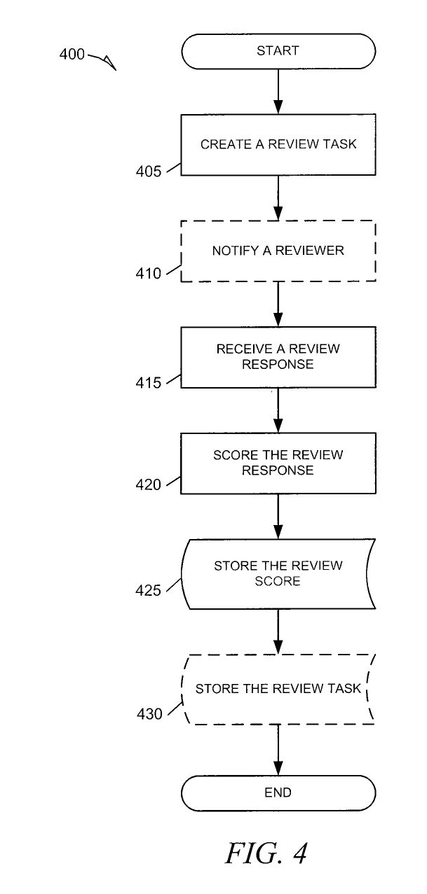

FIG. 4 is a flowchart depicting an example method 400 for creating, tracking, and evaluating review tasks. In this example, the method 400 includes operations for creating a review task at 405, optionally notifying a reviewer at 410, receiving a review response at 415, scoring the review response at 420, storing the review score at 425, and optionally storing the review task at 430. The method 400 can begin at 405 with a review task being created within the database 170. In an example, creating a review task can include selecting one or more review targets 320 and one or more reviewers 330. As noted above, the review targets 320 can include documents 322, presentations 324, and graphic files 326, among others. In certain examples, the review task 310 can include references (e.g., hyperlinks) to the one or more review targets 320 associated with the review task 310. In other examples, the review task 310 can contain copies of the review targets 320. For example, the database 170 can include data structures for a review target 320 that include binary large objects (BLOBs) to store a copy of the actual digital file. The review task, such as review task 310, can also include review metadata 340 associated with the review. In certain examples, the review task 310 can be created and stored within a database, such as database 170 or database 220. In other examples, the review task 310 can be created within a hierarchical file system accessible to the review server, such as server 110 or review server 230.

At 410, the method 400 can optionally include using the server 110 to send a notification to a reviewer selected to complete the review task created at operation 405. In an example, the notification can be sent in the form of an e-mail or other type of electronic message. The notification can include a reference to the review task, allowing the selected reviewer to simply click on the reference to access the review task.

At 415, the method 400 can continue with review server 230 receiving a review response from one of the reviewers. In an example, the review response can be submitted through a web browser or via e-mail. The review response can include text corrections, comments or annotations, evaluation of specific review criteria, and an overall rating of quality for the review target. In some examples, each individual response provided by the reviewer can be extracted into individual response items. The response items can then be stored in association with the review response and/or the review task. For example, if the reviewer made three annotations and two text corrections, the review server 230 can extract five response items from the review target.

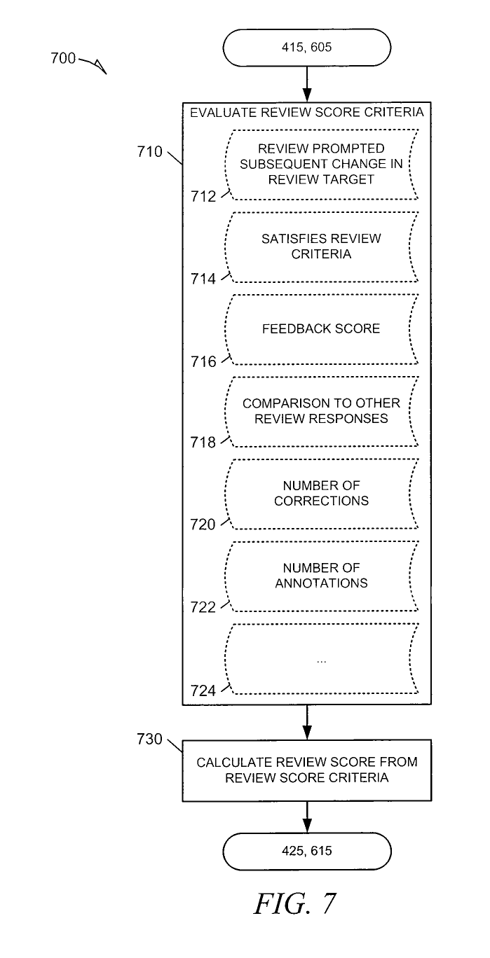

At 420, the method 400 continues with the review server 230 scoring the review response. In an example, scoring the review response can include determining how helpful the review was in creating subsequent revisions of the review target. Further details regarding scoring the review response are provided below in reference to FIG. 7. At 425, method 400 continues with the review server 230 storing the review score in the database 220. Method 400 can also optionally include, at 430, the review server 230 storing the updated review task in the database 220.

The method 400 is described above in reference to review server 230 and database 220, however, similar operations can be performed by the remote review server 260 in conjunction with the database 270. The method 400 can also be performed by server 110 and database 170, as well as similar systems not depicted within FIG. 1 or 2.

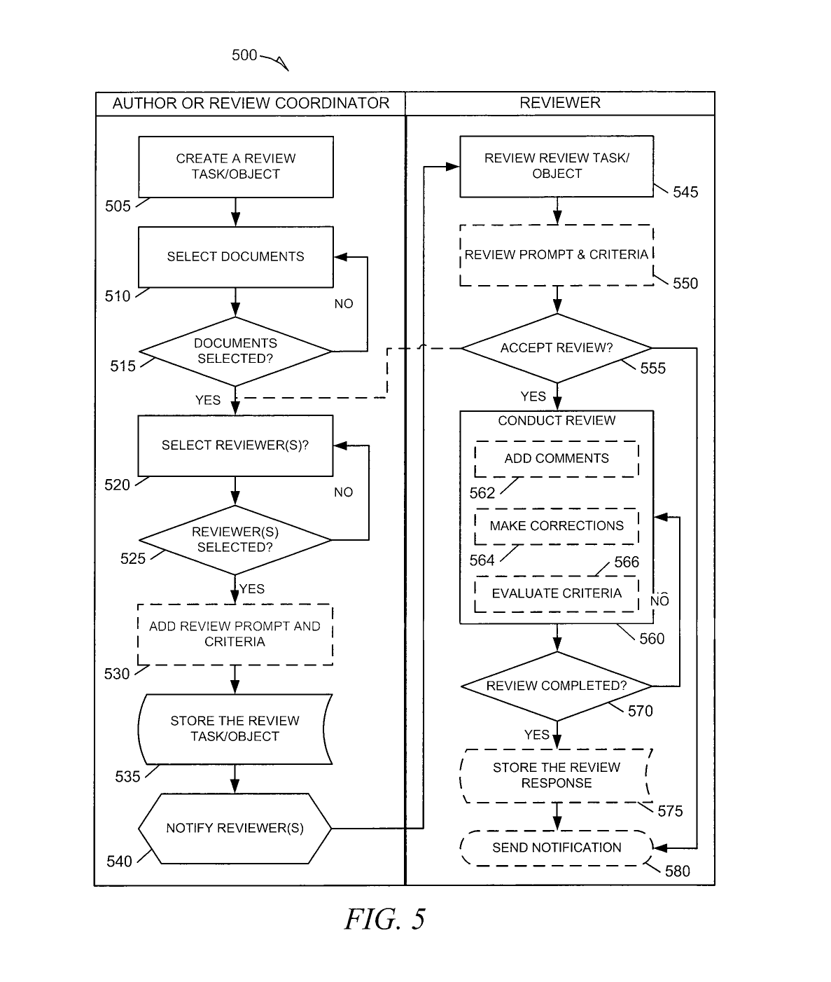

FIG. 5 is a flowchart depicting an example method 500 for creating and conducting review tasks. The method 500 depicts a more detailed example method for creating and conducting review tasks. In this example, the review task creation portion of method 500 includes operations for creating the review task at 505, selecting documents at 510, determining whether documents have been selected at 515, selecting reviewers at 520, determining whether reviewers have been selected at 525, optionally adding review prompt and criteria at 530, storing the review task at 535, and notifying the reviewers at 540. The review task conducting portion of method 500 includes operations for reviewing the review task at 545, optionally reviewing the prompt and review criteria at 550, determining whether the reviewer accepts the review task at 555, conducting the review at 560, determining whether the review task has been completed at 570, storing the review task at 575, and optionally sending a notification at 580. In some examples, conducting the review at 560 can include adding comments at 562, making corrections at 564, and evaluating review criteria at 566.

The method 500 can begin at 505 with the review server 230 creating a review task within the database 220. At 510, the method 500 can continue with the review server 230 receiving selected documents to review (e. g., review targets 310). At 515, the method 500 continues with the review server 230 determining whether any additional documents should be included within the review task. If all the review documents have been selected, method 500 continues at operation 520. If additional review documents need to be selected, method 500 loops back to operation 510 to allow for additional documents the selected. As noted, the term “documents” is being used within this example to include any type of review target.

At 520, the method 500 continues with the review server 230 prompting for, or receiving selection of, one or more reviewers to be assigned to the review task. At 525, the method 500 continues with the review server 230 determining whether at least one reviewer has been selected at operation 520. If at least one reviewer has been selected, method 500 can continue an operation 530 or operation 535. If review server 230 determines that no reviewers have been selected or that additional reviewers need to be selected, the method 500 loops back to operation 520.

At 530, the method 500 optionally continues with the review server 230 receiving a review prompt and/or review criteria to be added to the review task. The review prompt can include a basic description of the review task to be completed by the reviewer. The review criteria can include specific qualitative or quantitative metrics to evaluate the one or more review targets associated with the review task. At 535, the method 500 can complete the creation of the review task with the review server 230 storing the review task within the database 220. At 540, the method 500 continues with the review server 230 notifying the one or more reviewer's of the pending review task.

The method 500 continues at 545 with the reviewer accessing the review server 230 over the local area network 205 in order to review the review task. At 550, the method 500 continues with the review server 230 displaying the review prompt and review criteria to the reviewer, assuming the review task includes a review prompt and/or review criteria. At 555, the method 500 continues with the review server 230 determining whether the reviewer has accepted the review task. If the reviewer has accepted the review task, method 500 can continue at operation 560 with the reviewer conducting the review. However, if the reviewer rejects the review task at 555, the method 500 continues at 580 by sending a notification of the rejected review task. In some examples, the rejected review notification will be sent to a review coordinator or the author. In an example, the reviewer can reject the review by sending an e-mail modification back the review server 230. In certain examples, if the reviewer rejects the review at operation 555, the method 500 loops back to operation 520 for selection of a replacement reviewer.

At 560, the method 500 continues with the reviewer conducting the review task. In certain examples, conducting the review at 560 can include operations for adding comments at 562, making corrections at 564, and evaluating criteria at 566. In some examples, the reviewer can interact with the review server 230 to conduct the review. For example, the review server 230 can include user interface screens that allow the reviewer to make corrections, add comments, respond to specific criteria, and provide general feedback on the review target. In other examples, the reviewer can use a third-party software package, such as Microsoft® Word® to review the review target.

At 570, method 500 continues with the review server 230 determining whether the review task has been completed. If the reviewer has completed the review task, the method 500 can continue an operation 575. However, if the reviewer has not completed the review task, the method 500 loops back to operation 560 to allow the reviewer to finish the review task. At 575, the method 500 can optionally continue with the reviewer storing the completed review response. In certain examples, the review response can be stored by the review server 230 within the database 220. As discussed above, the operation 575 can also include extracting individual response items from the review response received from the reviewer. Optionally, method 500 can conclude at 580 with the reviewer sending out a notification of completion, which can include the review response. In certain examples, the review server 230 upon receiving the review response from the reviewer can send out a notification regarding the completed review task.

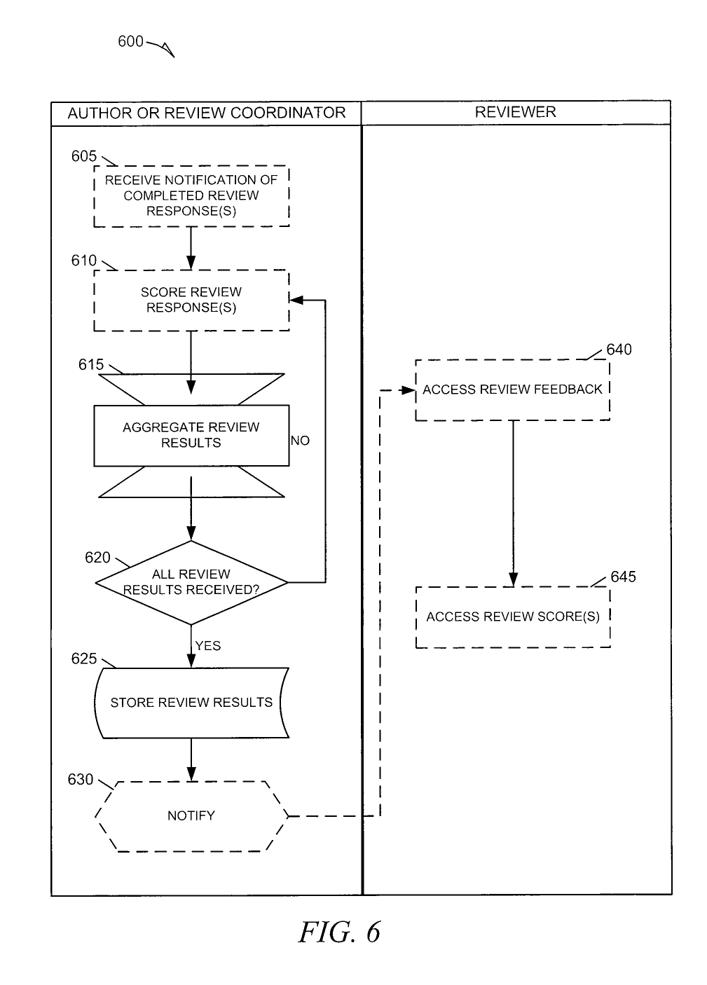

FIG. 6 is a flowchart depicting an example method 600 for tracking and evaluating review tasks and associated review responses. The method 600 can begin at 605 with a review coordinator or author receiving notification of a completed review task. In certain examples, the review coordinator or author can check the status of review tasks by accessing the review server 230. In some examples, the author or review coordinator can receive e-mail messages or short message service (SMS) type text messages from the review server 230 when review responses are received.

At 610, the method 600 can continue with the review server 230 scoring any review responses received from reviewers. As discussed above, methods of scoring review responses are detailed below in reference to FIG. 7. At 615, the method 600 continues with the review server 230 aggregating review results (review responses) associated with a review task. In certain examples, the aggregation process can include multiple review tasks and/or multiple reviewers. At 620, the method 600 continues with the review server 230 determining whether all review responses have been received. In an example, the review server 230 can determine whether all review responses have been received by comparing the reviewers assigned to the review task to the review responses received. If additional review responses still need to be received, the method 600 loops back to operation 610. If all the review responses for a particular review task have been received by the review server 230, then the method 600 can continue at operation 625.

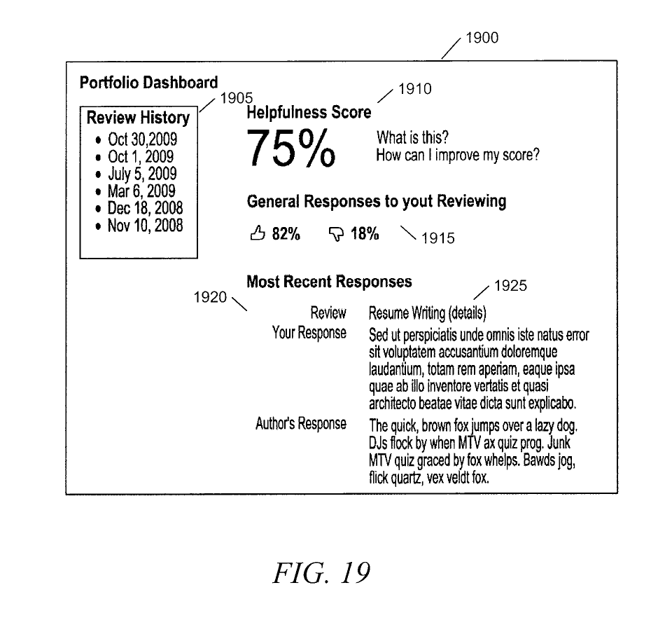

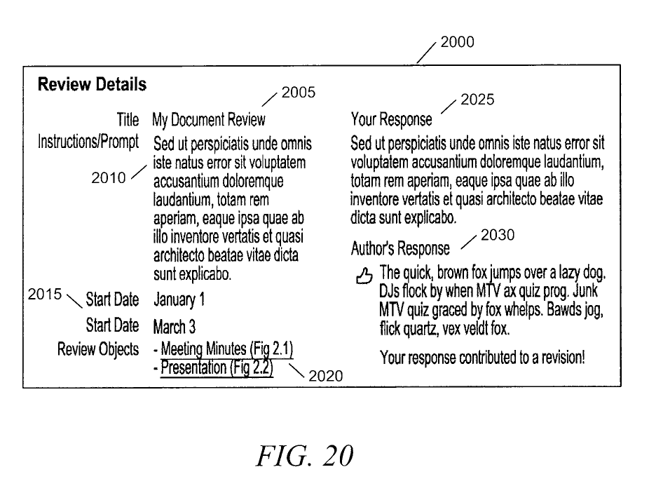

At 625, the method 600 continues with the review server 230 storing the review responses within the database 220. In an example, the review responses will be stored in association with the review task and the reviewer who submitted the review response. The method 600 can optionally continue at 630 with the review server 230 sending a notification to the one or more reviewers that review results (review scores and other aggregated results) can be accessed on the review server 230. At 640 and 650, the method 600 concludes with the review server 230 providing a reviewer access to review feedback and review scores related to any review responses provided by the reviewer. The information available to the reviewer is described further below in reference to FIGS. 19 and 20.

FIG. 7 is a flowchart depicting an example method 700 for scoring review responses including a series of optional scoring criteria. In this example, the method 700 includes two basic operations evaluating review score criteria at 710 and calculating a review score from the review score criteria at 730. The evaluating review score criteria, operation 710, can include many optional scoring criteria, including whether the review prompted subsequent change in review target at 712, whether the review satisfied review criteria within the review task at 714, the feedback score at 716, comparing the review response to other review responses at 718, the number of corrections suggested at 720, and the number of annotations added by the reviewer at 722. As noted by operation 724, the review score criteria can include additional custom scoring criteria that fit the particular deployment environment. For example, if the review system 100 were deployed within a law firm environment, the review score criteria could include the number of additional legal citations suggested by the reviewer.

At 712, the method 700 can continue with the review server 230 (or in some examples, the review scoring module 160) evaluating whether the review response prompted any subsequent changes in the review target. In an example, the review server 230 can perform a difference on the review target before and after changes prompted by the review response to determine locations where the review target was changed. The review server 230 can then compare change locations with locations of review response items within the review response to determine whether any of the review response items influenced the review target revisions.

At 714, the method 700 can include the review server 230 evaluating whether the review response (or any individual review response items within the review response) satisfies one or more of the review criteria included within the review task. In some examples, the review criteria include a specific question or Likert item and the review server 230 can verify that a response was included within the review response. In certain examples, the review criteria can be more open ended, in this situation, the review server 230 can use techniques such as keyword searching to determine whether the review response addresses the review criteria. In some examples, a review coordinator or the author can be prompted to indicate whether a review response includes a response to a specific review criterion.

At 718, the method 700 can include an operation where the review server 230 compares the review response to review responses from other reviewers to determine at least a component of the review score. In some examples, comparing review responses can include both quantitative and qualitative comparisons. A quantitative comparison can include comparing how many review criteria were met by each response or comparing the number of corrections suggested. A qualitative comparison can include comparing the feedback score provided by the author.

At 720, the method 700 can include an operation where the review server 230 evaluates the number of corrections suggested by the reviewer. Evaluating the number of corrections can include comparing to an average or a certain threshold, for example. At 722, the method 700 can include the review server 230 evaluating the number of annotations or revision suggestions provided by the reviewer. Again, evaluating the number of annotations can include comparing to an average or a certain threshold to determine a score.

As noted above, the method 700 can include additional review score criteria. In some examples, review score criteria can be programmed into the review task by the author or review coordinator. In other examples, a course instructor can determine the specific criteria to score reviews against. In each example, the review score criteria can be unique to the particular environment.

### EXAMPLE USER-INTERFACE SCREENS

The following user-interface screens illustrate example interfaces to the systems for creating, tracking, and evaluating review tasks, such as system 200. The example user-interface screens can be used to enable the methods described above in FIGS. 4-7. The illustrated user-interface screens do not necessarily depict all of the feature or functions described in reference to the systems and methods described above. Conversely, the user-interface screens may depict features or functions not previously discussed.

FIG. 8A-B are example user-interface screens for creating a review task. In the example depicted in FIG. 8A, the user-interface (UI) screen, create review UI 800, includes UI components for inputting the following information to define a review task. The UI components in the create review UI 800 include a title 805, a review instructions (prompt) 810, a start date 815, an end date 820, reviewers 825, review metrics 840, review criteria 850, and review objects 860. The create review UI 800 also includes a save as draft button 870 and a create review button 875. In certain examples, the create review UI 800 can also include a cancel button (not shown).

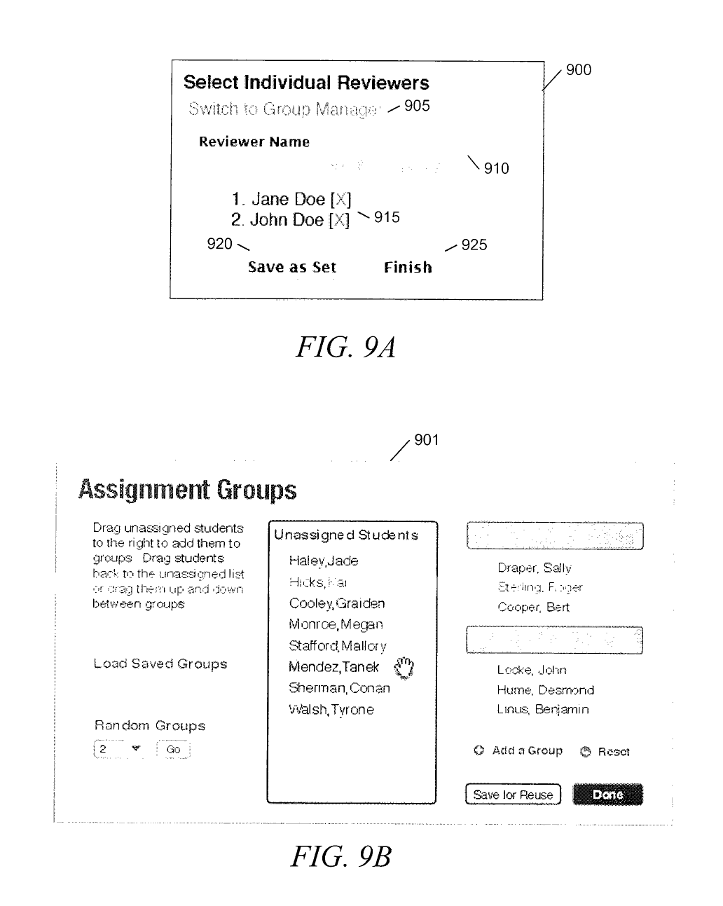

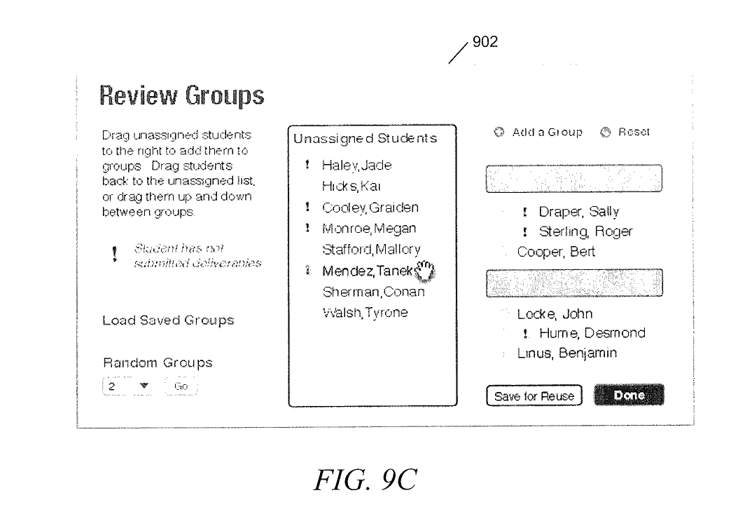

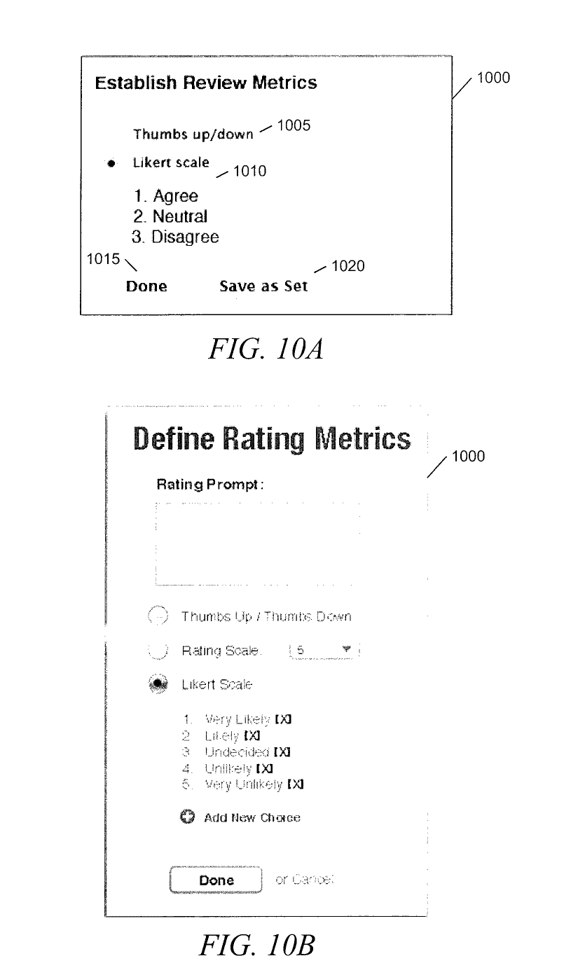

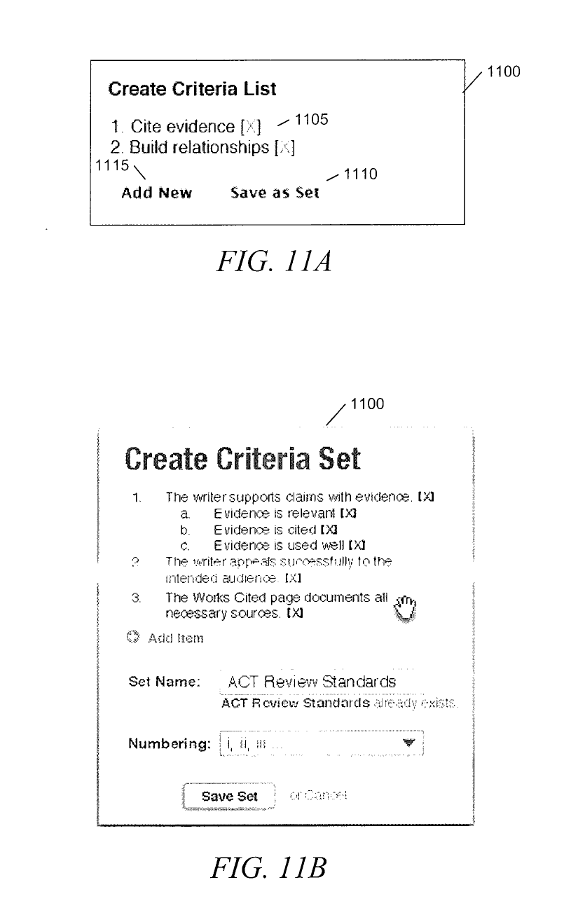

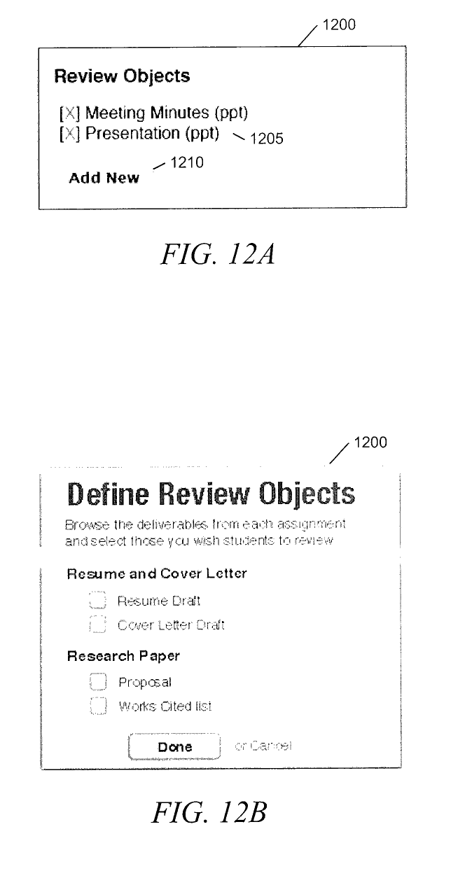

The title component 805 can be used to enter or edit a title of a review task. In an example, the instructions component 810 can be used to enter instructions to a reviewer. The review task can be given a start and end date with the start date component 815 and the end date component 820, respectively. The reviewer's component 825 displays the reviewers selected to provide review responses to a review task. In this example, the create review UI 800 includes a manage reviewers link 830 that can bring up a UI screen for managing the reviewers (discussed below in reference to FIG. 9). The metrics component 840 displays quantitative evaluation questions regarding the review task. For example, the metrics component 840 is displaying a Likert item (e.g., a question regarding the review task that includes a Likert scale answer). In this example, the review creation UI 800 includes a manage metrics link 845 that launches a UI screen for managing review metrics (discussed below in reference to FIG. 10). The criteria component 850 displays the review criteria created for a review task. In this example, create review UI 800 includes a manage criteria link 855 that can launch a UI screen for managing review criteria (discussed below in reference to FIG. 11). The review objects component 860 displays the items to be reviewed within this review task (note, review objects are also referred to within this specification as review targets). For example, the create review UI 800 includes two review targets a “Meeting Minutes” PowerPoint® and a “Presentation” PowerPoint®. In this example, the create review UI 800 includes a manage objects link 865 that can launch a UI screen for managing review targets (objects). The review objects UI 1200 is discussed below in reference to FIG. 12. FIG. 8B illustrates another example user-interface screen for creating a review.

FIG. 9A-C are example user-interface screens for selecting reviewers to associate with a review task. FIG. 9A is an example user-interface screen for selecting individual reviewers to associate with a review task. In this example, the UI screen, select individual reviewers UI 900, includes UI components for switching to group manager 905, entering a reviewer name 910, selected reviewer list 915, a save set button 920, and a finish button 925. In certain examples, the select individual reviewers UI 900 can also include a cancel button (not shown). The reviewer name component 910 allows entry of the name of a reviewer. In certain examples, the reviewer name component 910 can also include a search button (not shown) that can enable searching for reviewers within a database, such as database 220. Reviewers selected for the review task can be listed within the selected reviewers list 915. In an example, the save set button 920 can save the selected set of reviewers within the review task. Selecting the finish button 925 can return a user to the create review task UI 800 depicted in FIG. 8. FIG. 9B is an example user-interface screen for assignment of users to groups. FIG. 9C is an example user-interface for selecting review groups, according to an example embodiment.

FIG. 10A-B are example user-interface screens for establishing review metrics to associate with a review task. FIG. 10 is an example user-interface screen for establishing review metrics to associate with a review task. In this example, the UI screen, establish review metrics UI 1000, includes UI components for selecting a thumbs up/down 1005 or a Likert scale 1010, the done button 1015, and save as set button 1020. In this example, the establish review metrics UI 1000 provides a choice between a binary thumbs up/down quantitative metric or a three-level Likert scale metric. In some examples, establish review metrics UI 1000 can enable the addition of multiple review metrics for reviewing specific portions of the review task. For example, establish review metrics UI 1000 can include UI components for creating a review metric to be associated with each of the one or more review targets added to the review task.

FIG. 11A-B are example user-interface screens for creating a list of review criteria to associate with a review task. FIG. 11 is an example user-interface screen for creating a list of review criteria to associate with a review task. In this example, the UI screen, create criteria list UI 1100, contains UI components including a criteria list 1105, and add new criteria button 1115, and a save as set button 1110. Create criteria list UI 1100, displays the review criteria as the criteria are added within the criteria list 1105. The add new button 1115 can be used to create a new criteria. Finally, the save as set button 1110 stores the created set of criteria into the review task (e.g., within a table in the database 220 linked to the review task).

FIG. 12A-B are example user-interface screens for selecting review targets to associate with a review task. FIG. 12 is an example user-interface screen for selecting review targets to associate with a review task. In this example, the UI screen, review objects UI 1200, contains a list of review targets 1205 and an add new button 1210. In certain examples, the review objects UI 1200 can also include a save as set button and a cancel button (not shown). The add new button 1210 enables selection of an additional review target to be added to the review target list 1205. As discussed above, review tasks can include multiple review targets.

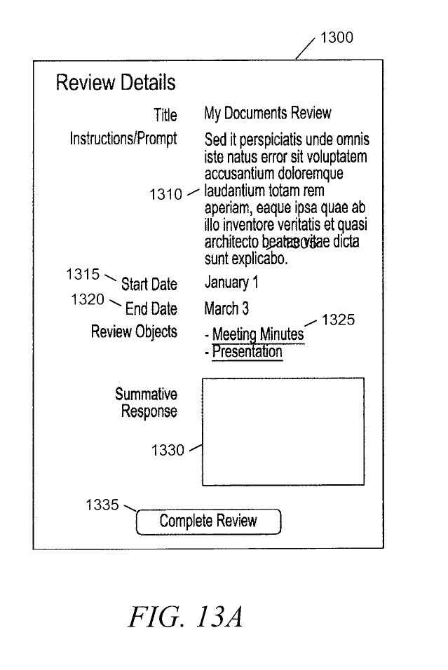

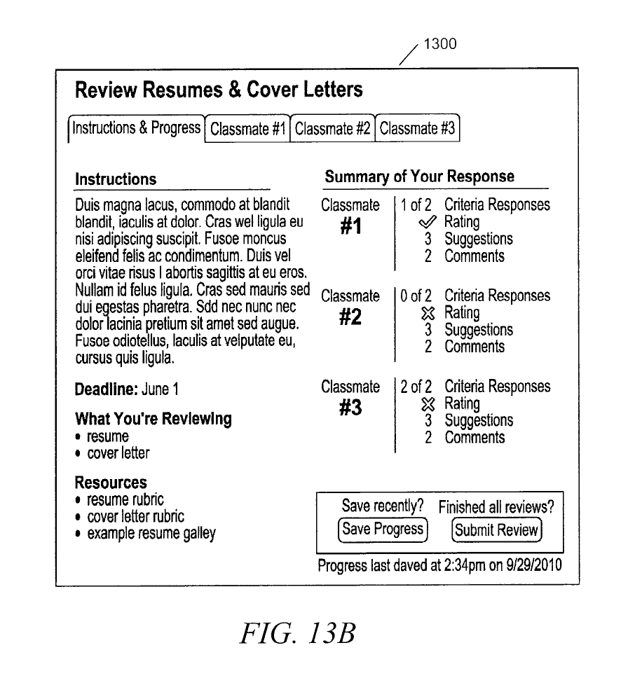

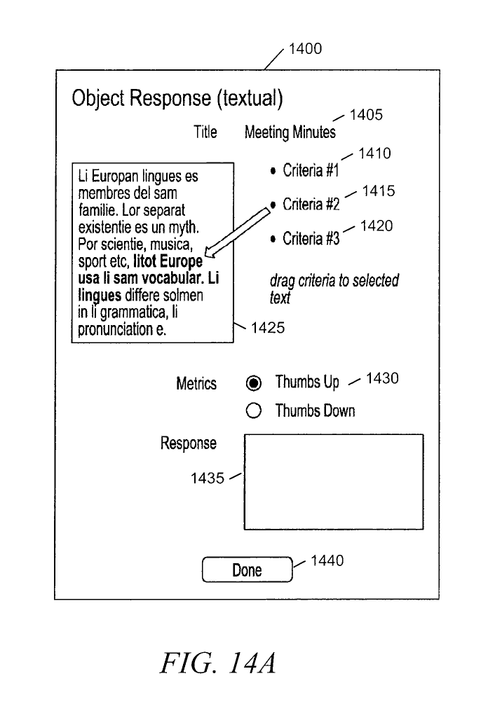

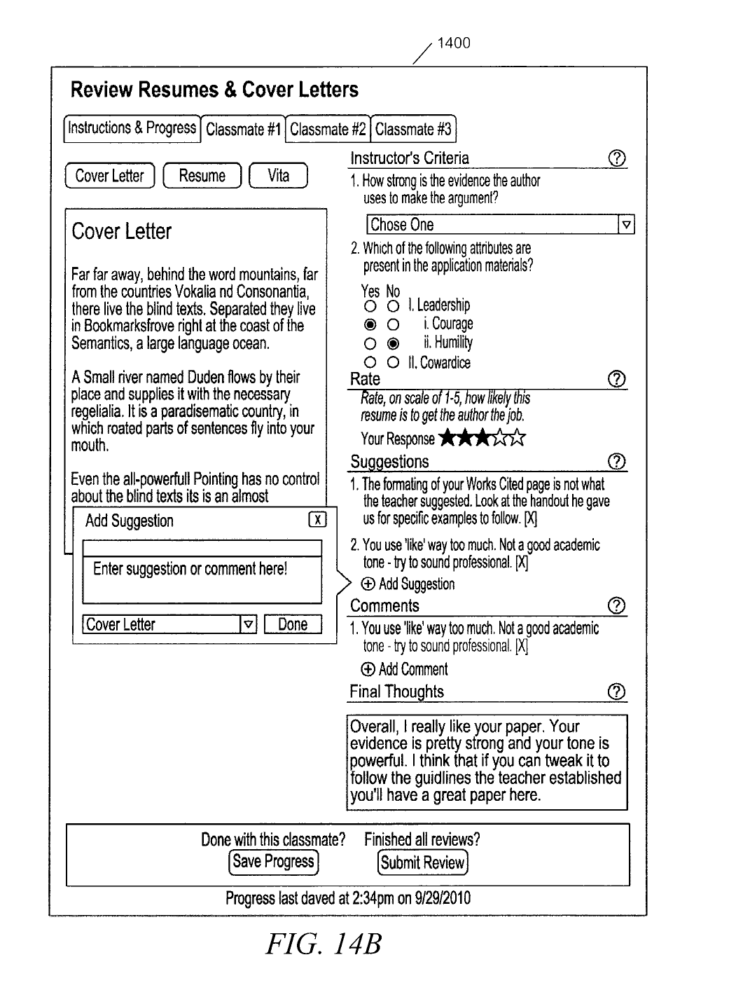

FIG. 13A-B are example user-interface screens for a reviewer to view review details associated with a review task. FIG. 13 is an example user-interface screen for a reviewer to view review details associated with a review task. In this example, the UI screen, review details UI 1300, contains UI components including a title display 1305, an instructions (prompt) display 1310, a start date display 1315, an end date display 1320, a list of review objects (targets) 1325, a summative response component 1330, and a complete review button 1335. In this example, the review objects list 1325 includes links (hyperlinks) to the listed review targets (hyperlinks indicated by the underlined title). Selecting one of the review targets in the review objects list 1325 can launch a separate object response UI 1400 (discussed below in reference to FIG. 14). The summative response component 1330 can accept entry of a reviewer's general impressions of the review task (or review targets). Selecting the complete review button 1335 can send an indication to the review server 230 that the reviewer has finishing reviewing the one or more review targets associated with the review task. In certain examples, selecting the complete review button 1335 causes the completed review response to be sent to the review server 230.

FIG. 14A-B are example user-interface screens for a reviewer to respond to review criteria associated with a review task. FIG. 14 is an example user-interface screen for a reviewer to review a selected review target within the review system 200. In this example, the UI screen, object response UI 1400, contains UI components including a title display 1405, review criteria 1410, 1415, 1420, a review target display component 1425, a review metrics component 1430, a response field 1435, and a done button 1440. The object response UI 1400 can also include a cancel button (not shown). In some examples, the review target display component 1425 can be interactive, allowing the reviewer to scroll through various portions of the review target. In an example, the reviewer can drag one of the review criteria 1410, 1415, 1420 onto the review target display component 1425 when the portion of the review target that satisfies the criteria is displayed. In certain examples, the reviewer can highlight specific portions of the review target within the review target display component 1425, providing additional control over what portion of the review target meets the selected criteria (e.g., FIG. 14 illustrates criterion 1415 being dragged onto a highlighted portion of the review target). The review can also add annotations within the response field 1435. In some examples, annotations entered into the response field 1435 can be linked to portions of the review target (e.g., by dragging the entered text onto the selected portion of the review target displayed within the review target display component 1425). In this example, selecting the done button 1440 can return the reviewer to the review details UI 1300, depicted in FIG. 13 and discussed above.

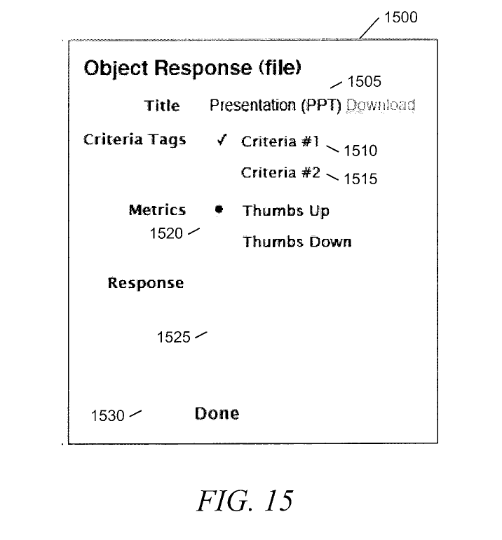

FIG. 15 is an example user-interface screen for a reviewer to review a selected review target within a third-party software package. The UI screen, object response UI 1500, contains UI components including a title display 1505, review criteria 1510, 1515, review metrics 1520, a response field 1525, and a done button 1530. In this example, the object response UI 1500 can enable a reviewer to use a third-party software package to review the review target. For example, the reviewer can review a Word® document using the review functionality within Microsoft® Word®. In certain examples, the title display 1505 will include a download link to provide reviewer with direct access to the review target. In this example, the review criteria 1510, 1515, can be checked off by the reviewer after reviewing the review target. Similarly, the reviewer can use the review metrics component 1520 to provide feedback regarding the requested review metrics.

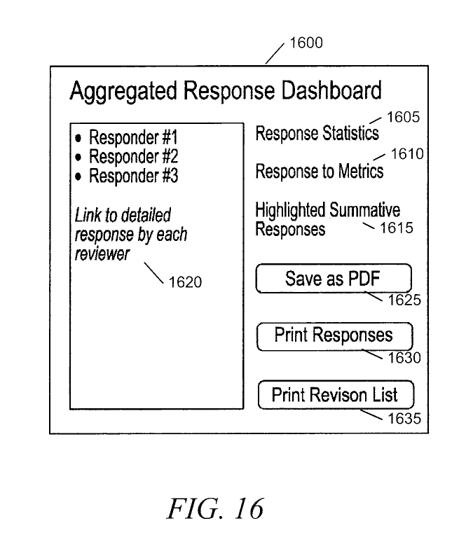

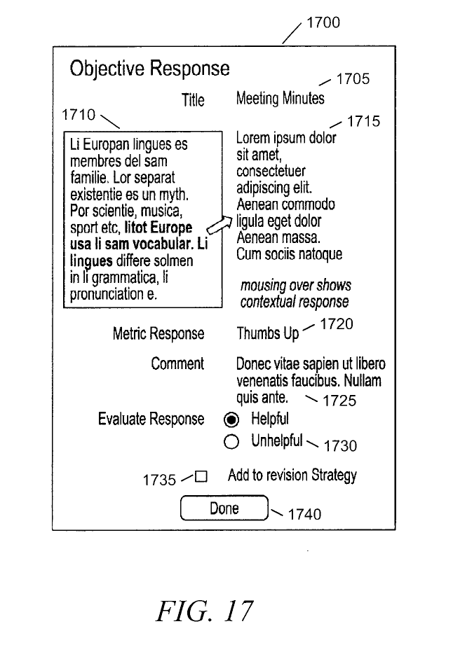

FIG. 16 is an example user-interface screen providing an overview of one or more review tasks. In this example, the UI screen, aggregated response dashboard UI 1600, contains UI components including a response statistics display 1605, a response to metrics display 1610, a highlighted summative response display 1615, a list of responses from individual reviewer's display 1620, a save as PDF button 1625, a print responses button 1630, and a print revision list button 1635. In this example, clicking on one of the responses listed within the list of responses from individual reviewers display 1620 can launch an object response UI 1700 (discussed in detailed below in reference to FIG. 17). The save as PDF button 1625 can save an aggregated response report to a portable document format (PDF) document (PDF was created by Adobe Systems, Inc. Of San Jose, Calif.). The print responses button 1630 can send each of the individual review responses to a printer. The print revision list button 1635 can send a list of revision suggestions from the aggregated review responses to a printer. In certain examples, the aggregated response dashboard UI 1600 can also include buttons to view a list of suggested revisions from the aggregated responses.

FIG. 17 is an example user-interface screen providing detail associated with a specific review response. In this example, the UI screen , object response UI 1700, contains UI components including a title display 1705, a review target display 1710, an contextual response display 1715, a metric response display 1720, a review comment/feedback field 1725, an evaluate response control 1730, an add to revision strategy control 1735, and a done button 1740. In certain examples, the review coordinator or author can use the object response UI 1700 to review and evaluate individual review responses. In this example, the review target display 1710 is interactively linked with the contextual response display 1715 to display review response information for the portion of the review target selected within the review target display 1710. In certain examples, the metric response display 1720 is also interactively linked to the review target display 1710. The review comment/feedback field 1725 can enable the author or review coordinator to provide feedback on the reviewer's review responses. In this example, the evaluate response control 1730 provides a quick and easy mechanism to evaluate the reviewer's responses as helpful or unhelpful. In other examples, the evaluate response control 1730 can include additional granularity. Finally, the add to revision strategy control 1735 enables the author or review coordinator to indicate that this review response (or response item) should be added to the revision list (e.g., considered when developing the next revision of the review target).

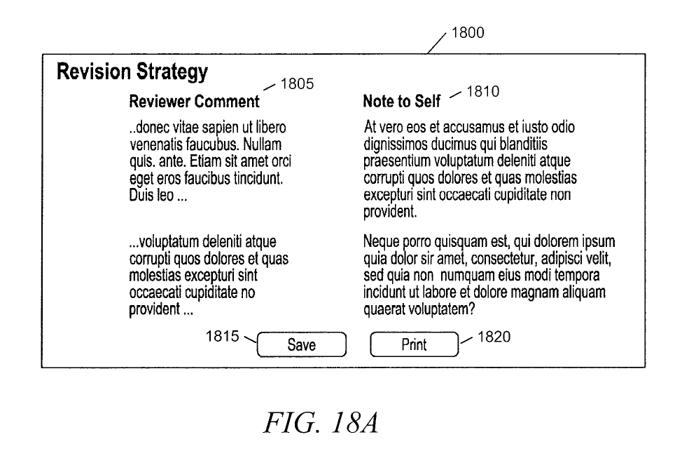

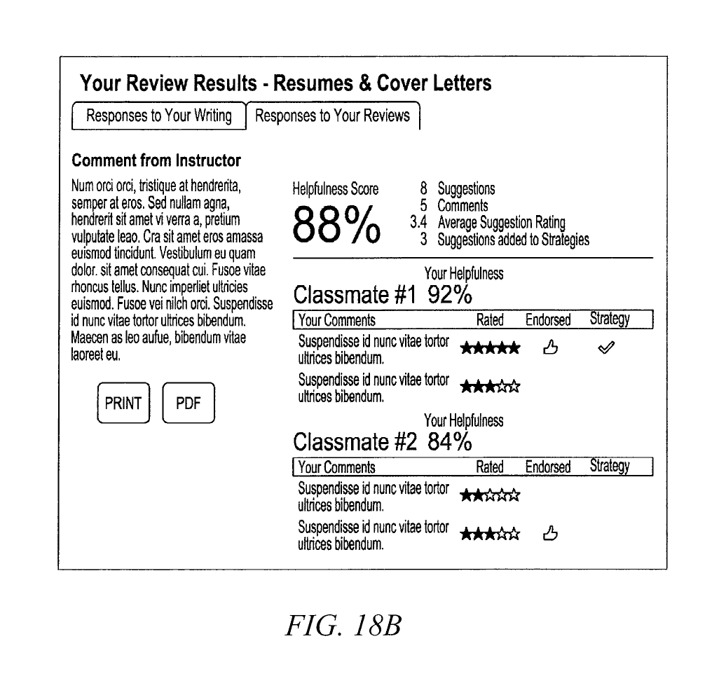

FIG. 18A-B are example user-interface screens displaying a collection of review responses and associated notes. FIG. 18 is an example user-interface screen displaying a collection of review responses and associated notes. In this example, the UI screen, revision strategy UI 1800, contains UI components including a list of reviewer comments 1805, a list of notes to self 1810, a save button 1815, and a print button 1820. The revision strategy UI 1800 can provide a summary of response items flagged for potential reuse and associated comments added by the author or review coordinator.

FIG. 19 is an example user-interface screen providing a portfolio dashboard view for an individual reviewer. In general this UI screen, a portfolio dashboard UI 1900, provides an individual reviewer an overview of review activity and review evaluations. In this example, the portfolio dashboard UI 1900 contains UI components including a list of review history 1905, a helpfulness score 1910, a general responses to your reviewing display 1915, and a most recent responses display 1920. The most recent responses display 1920 can also include a link to display additional details (a review details UI 2000 is described below in reference to FIG. 20).

In an example, the list of review history 1905 can include a list of all the review responses submitted by a particular reviewer. The helpfulness score display 1910 can display an aggregate of the reviewers review scores for all reviews included in the portfolio dashboard UI 1900. The general responses to your reviewing display 1915 can aggregate all of the thumbs up/down responses received for each of the review responses. The most recent responses display 1920 includes additional detail about at least one of the reviewer's most recent review responses. Clicking on the details link 1925 can display a review details UI 2000, described in reference to FIG. 20 below.

FIG. 20 is an example user-interface screen providing review evaluation details associated with a specific individual review response. In general, the review details UI 2000 provides a detailed view of an individual review response. The review details UI 2000 contains UI components including a title component 2005, an instructions/prompt display 2010, start/end dates 2015, a list of review targets 2020, a your response display 2025, and an author's response display 2030.

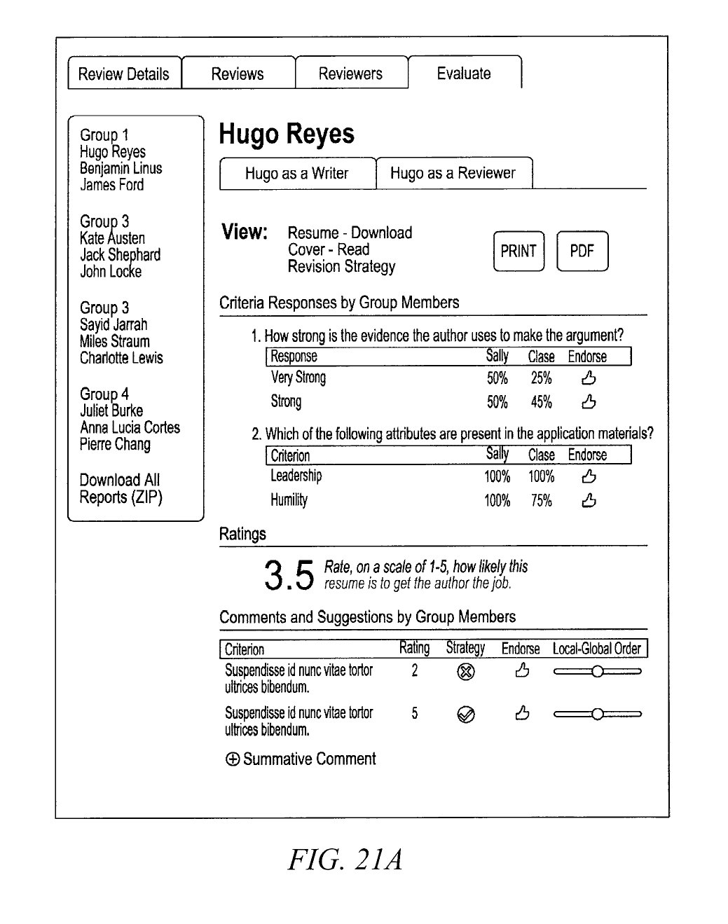

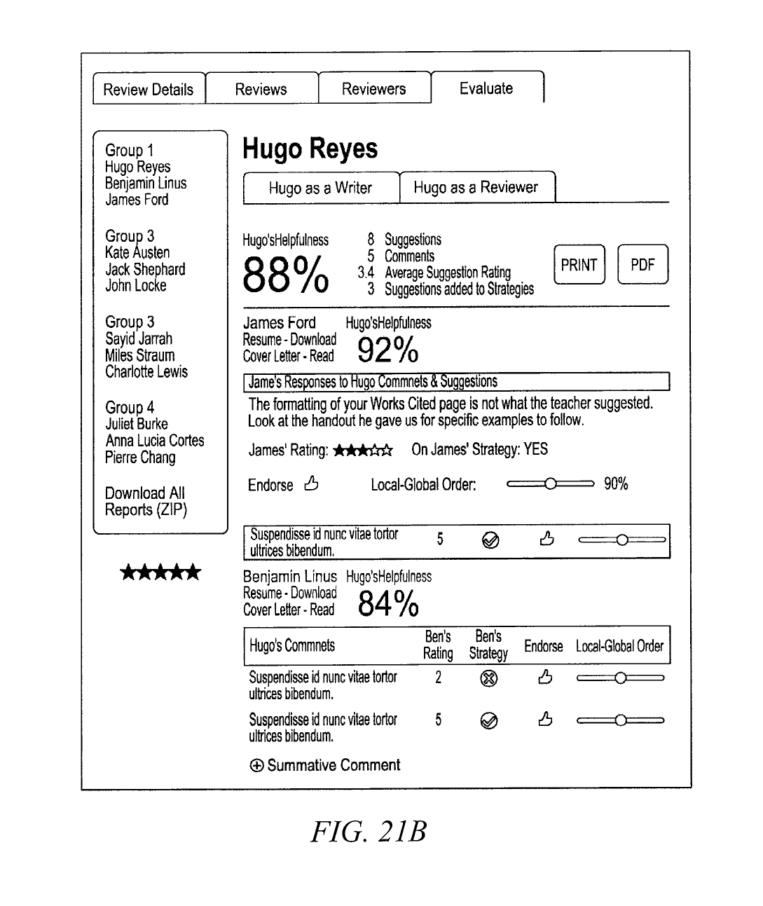

FIG. 21A-B are example user-interface screens providing user evaluation details related to activities as a reviewer and a writer. In this example, FIG. 21A-B combine aspects discussed in FIG. 20 and FIG. 19 into a tabbed interface.

### MODULES, COMPONENTS AND LOGIC

Certain embodiments are described herein as including logic or a number of components, modules, engines, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a SaaS. For example, at least some of the operations may be performed by a group of computers (as examples of machines including processors), these operations being accessible via a network (e.g., the Internet) and via one or more appropriate interfaces (e.g., APIs).

### ELECTRONIC APPARATUS AND SYSTEM

Example embodiments may be implemented in digital electronic circuitry, or in computer hardware, firmware, software, or in combinations of these. Example embodiments may be implemented using a computer program product (e.g., a computer program tangibly embodied in an information carrier, in a machine-readable medium for execution by, or to control the operation of, data processing apparatus, a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, for example, a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### EXAMPLE MACHINE ARCHITECTURE AND MACHINE-READABLE MEDIUM

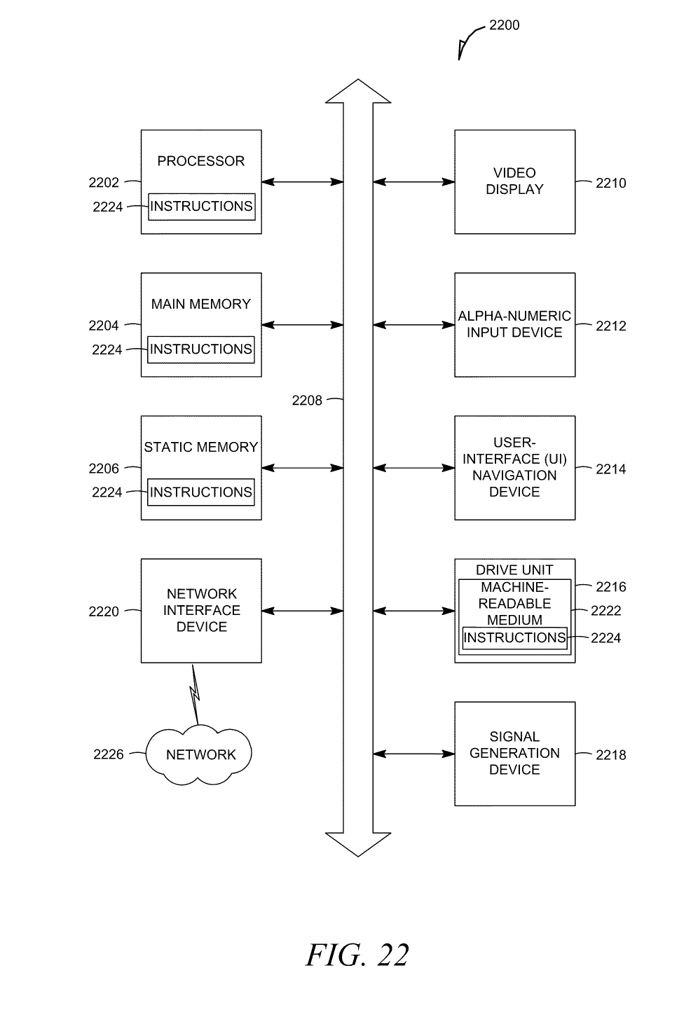

FIG. 22 is a block diagram of a machine in the example form of a computer system 2200 within which instructions for causing the machine to perform any one or more of the methodologies discussed herein may be executed. As such, the computer system 2200, in one embodiment, comprises the system 2200. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2200 includes a processor 2202 (e.g., a central processing unit (CPU), a graphics processing unit (GPU) or both), a main memory 2204, and a static memory 2206, which communicate with each other via a bus 2208. The computer system 2200 may further include a video display unit 2210 (e.g., a liquid crystal display (LCD) or a cathode ray tube (CRT)). The computer system 2200 also includes an alphanumeric input device 2212 (e.g., a keyboard), a user interface (UI) navigation device 2214 (e.g., a mouse), a disk drive unit 2216, a signal generation device 2218 (e.g., a speaker) and a network interface device 2220.

### MACHINE-READABLE MEDIUM

The disk drive unit 2216 includes a machine-readable medium 2222 on which is stored one or more sets of data structures and instructions (e.g., software) 2224 embodying or utilized by any one or more of the methodologies or functions described herein. The instructions 2224 may also reside, completely or at least partially, within the main memory 2204 and/or within the processor 2202 during execution thereof by the computer system 2200, with the main memory 2204 and the processor 2202 also constituting machine-readable media.

While the machine-readable medium 2222 is shown in an example embodiment to be a single medium, the term “machine-readable medium” may include a single medium or multiple media (e.g., a centralized or distributed database, and/or associated caches and servers) that store the one or more data structures and instructions 2224. The term “machine-readable medium” shall also be taken to include any tangible medium that is capable of storing, encoding or carrying instructions for execution by the machine and that cause the machine to perform any one or more of the methodologies of the present embodiments of the invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### TRANSMISSION MEDIUM

The instructions 2224 may further be transmitted or received over a communications network 2226 using a transmission medium. The instructions 2224 may be transmitted using the network interface device 2220 and any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for making contextual recommendations to users on a network-based marketplace have been described. Although the present embodiments of the invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, if used the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The claimed invention includes:

1. A system comprising:
a database;
a computer communicatively coupled to the database, the computer including a memory and a processor, the memory storing instructions, which when executed by the processor, cause the system to perform operations to:
create a review object within the database, the review object including references to a review target and a reviewer;
send a notification to the reviewer regarding the review object, the notification including information for the reviewer about the review object;
receive a review response from the reviewer associated with the review object;
store the review response from the reviewer within the database associated with the review object;
score the review response to create a review score for the reviewer; and
store the review score within the database associated with the reviewer and the review object.

2. The system of claim 1, wherein the create a review object operation includes a review criterion to be evaluated by the reviewer in regard to the review target; and
wherein the review criterion includes a question regarding a specific portion of the review target.

3. The system of claim 2, wherein the question includes a Likert scale response structure.

4. The system of claim 2, wherein the review criterion is selected from a group of pre-defined criteria stored within the database, and
wherein the group of pre-defined criteria is related to an assignment type associated with the review target.

5. The system of claim 1, wherein the receive a review response operation includes automatically parsing the review target to obtain a response item, the response item including data provided by the reviewer associated with the review target.

6. The system claim 1, wherein the score the review response operation includes determining whether the review response prompted subsequent changes in the review target.

7. The system of claim 6, wherein the determining whether the review response prompted subsequent changes in the review target includes comparing a change location within the review target to a location within the review target associated with the review response.

8. The system of claim 1, wherein the score the review response operation includes determining whether the review response includes a response item associated with a review criteria included within the review object.

9. The system of claim 1, wherein the score the review response operation includes factoring in a feedback score provided by an author of the review target into the review score.

10. The system of claim 1, wherein the create a review object operation includes assigning a plurality of additional reviewers to the review object.

11. The system of claim 10, wherein the score the review response operation includes:
determining a first location within the review target associated with the review response; and
determining a number of review responses provided by the plurality of additional reviewers with a location within the review target similar to the first location within the review target.

12. The system of claim 10, wherein the processor performs an additional operation to aggregate a plurality of review responses received from the reviewer and the plurality of additional reviewers.

13. A method comprising:
receiving a plurality of parameters defining a review task, the plurality of parameters including a review target and a reviewer;
receiving a review response associated with the review task from the reviewer;
scoring, using one or more processors, the review response to create a review score for the reviewer; and
storing the review score associated with the reviewer and the review response within a database.

14. The method of claim 13, wherein the receiving the review response includes extracting data provided by the reviewer into a response item.

15. The method of claim 14, wherein the response item is one of a group including:
a comment;
a correction; or
a response to a review criteria.

15. The method of claim 13, wherein the receiving the review response includes receiving an e-mail with the review target attached, the review target including metadata added by the reviewer, the metadata containing a plurality of response items.

16. The method of claim 13, wherein the receiving a plurality of parameters defining the review task includes a parameter defining a review criterion to be evaluated by the reviewer in regard to the review target.

17. The method of claim 16, wherein the review criterion includes a question regarding a specific portion of the review target.

18. The method of claim 17, wherein the question includes a Likert scale response structure.

19. The method of claim 16, wherein the review criterion is selected from a group of pre-defined criteria, wherein the group of pre-defined criteria is related to an assignment type associated with the review target.

20. The method of claim 13, wherein the receiving the review response includes automatically parsing the review target to obtain a response item, the response item including data provided by the reviewer associated with the review target.

21. The method claim 13, wherein the scoring the review response includes determining whether the review response prompted subsequent changes in the review target.

22. The method of claim 38, wherein the determining whether the review response prompted subsequent changes in the review target includes:
comparing the review target with a subsequent version of the review target to create a list of change locations within the subsequent version of the review target; and
comparing a location with the review target associated with the review response to the list of change locations within the subsequent version of the review target.

23. The method of claim 13, wherein the creating the review task includes assigning the review task to a plurality of reviewers.

24. The method of claim 23, wherein the receiving the review response includes receiving a plurality of review responses, each of the plurality of review responses including an associated feedback score; and
wherein the scoring the review response includes determining an average feedback score from the plurality of review responses and comparing for each of the plurality of review responses the feedback score associated with the review response to the average feedback score.

25. The method of claim 13, further including maintaining a history of review responses for the reviewer, wherein the history of review responses includes a plurality of past review responses and an aggregated review score.

26. A computer-readable medium comprising instructions, which when executed on one or more processors perform operations to:
receive a plurality of parameters defining a review task, the plurality of parameters including a review criteria and references to a review target and a reviewer;
store the review task within a database;
receive a review response associated with the review task from the reviewer; and
storing the review score associated with the reviewer and the review response within the database.
